(19) United States
(12) Patent Application Publication
(10) Pub. No.: US 2010/0098908 A1
(43) Pub. Date: Apr. 22, 2010

(54) MOULDING COMPOSITIONS FOR MATT PMMI MOULDINGS

(75) Inventors: Klaus Schultes, Darmstadt (DE); Ursula Golchert, Dieburg (DE); Stefan Nau, Buettelborn (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/525,160

(22) PCT Filed: Oct. 30, 2007
(86) PCT No.: PCT/EP2007/061656

§ 371 Date: Jul. 30, 2009

(30) Foreign Application Priority Data
Jan. 30, 2007 (DE) 10 2007 005 428.0

(51) Int. Cl. C04B 35/00; B29C 45/00; B32B 3/00

(52) U.S. Cl. 428/141; 501/153; 501/1; 264/328.1

(57) ABSTRACT

Moulding composition, comprising, in each case based on the total weight of the moulding composition,

A) from 83% by weight to 99.5% by weight of a polymer matrix which is composed of at least one (meth)acrylimide (co)polymer,

B) from 0.5% by weight to 17.0% by weight of ceramic beads,

where the melt volume index MVR of the moulding composition, measured to ISO 1133 at 260° C. using 10 kg, is from 1.0 cm³/10 min to 20.0 cm³/10 min.

The moulding composition can be used for production of mouldings with a velvet-matt and preferably rough surface. These mouldings are particularly suitable as parts of household devices, of communications devices, of hobby equipment or of sports equipment, or as bodywork parts or parts of bodywork parts in automobile construction, shipbuilding or aircraft construction, or as parts for illuminants, signs or symbols, retail outlets or cosmetics counters, containers, household-decoration items or office-decoration items, furniture applications, shower doors and office doors, or else as parts in the construction industry, as walls, as window frames, bench seats, lamp covers, diffuser sheets, or for automobile glazing.

The invention relates to a moulding composition for matt mouldings, and also to the corresponding mouldings, and their use.

### PRIOR ART

Moulding compositions based on polymethacrylimide (PMMI) are used for a very wide variety of applications. To this end, the compositions are usually injection-moulded or extruded to give mouldings. These mouldings feature the properties typical of PMMI, e.g. high scratch resistance, weathering resistance, heat resistance, and excellent mechanical properties, such as modulus of elasticity, and good stress-cracking resistance.

Extruded or co-extruded PMMI mouldings are very versatile: by way of example, extruded or co-extruded sheets are used not only for exteriors, in particular for automobile add-on parts, construction components, sports-equipment surfaces and lamp covers, but also in interiors, in particular in the furniture industry, and for lamp covers and interior fitting-out of automobiles.

These applications do not only require extruded or coextruded PMMI mouldings with a transparent, smooth surface but also often require matt, and preferably rough, surfaces, because these have more attractive feel and because of the optical effect. This type of surface is mostly achieved by using moulding compositions into which organic or inorganic particles have been incorporated.

However, when organic matting agents are used, the resulting modified moulding compositions do not exhibit good mechanical properties, and in particular do not exhibit satisfactory abrasion resistance. It is also often necessary to use large amounts of light stabilizers in order to achieve good weathering resistance of the corresponding mouldings.

A disadvantage in the processing of the inorganic matting agents commonly used, e.g. talc, is complicated incorporation into the PMMI moulding composition. By way of example, very high shear energies have to be used during compounding, in order to incorporate the inorganic matting agent uniformly into the moulding composition. If homogeneous distribution of the scattering agent in the moulding composition has not been ensured, this is discernible at the surface of the resultant extruded or co-extruded PMMI mouldings (defects or irregularities, e.g. pimples). The other properties of the material of such mouldings are also unsatisfactory.

WO 02/068519 describes a solid surface material composed of a matrix, e.g. of an acrylic resin, and of ceramic beads dispersed therein, for example W-410 Zeeospheres®. The ceramic beads have a functional coating which reacts with the resin of the matrix and covalently bonds the beads to the matrix. The surface material of WO 02/068519 features high flame resistance.

WO 03/054099 relates to an adhesive strip whose uppermost layer encompasses a transparent resin and a matting agent, e.g. ceramic beads.

WO 97/21536 discloses an extrusion process which can introduce matting agents, e.g. ceramic beads, into a thermoplastic polymer.

U.S. Pat. No. 5,787,655 describes an anti-slip film composed of a thermoplastic polymer, into which inorganic beads, e.g. ceramic beads, have been incorporated.

U.S. Pat. No. 5,562,981 relates to the structure of a lorry trailer. The side walls of the trailer encompass fibre-reinforced plastics into which ceramic beads were mixed for additional reinforcement of the walls.

WO 2005/105377 discloses a composition composed of a thermoplastic whose processing temperature is at least 280° C., of super-abrasive particles and of a filler, e.g. ceramic beads. The composition is used for production of abrasive articles.

### OBJECT AND ACHIEVEMENT OF OBJECTS

It was then an object of the present invention to find a moulding composition which can be used for production of mouldings with a fine-matt surface. This moulding composition should be preparable and processable in the simplest possible manner, in particular with relatively low energy cost. The articles that can be produced from the moulding composition should moreover have the best possible optical and mechanical properties, the best possible long-term stability and weathering resistance, and also a velvet-matt surface which has the least possible gloss and the greatest possible homogeneity. The articles that can be produced from the moulding composition should also, if possible, have a rough surface.

A moulding composition with all of the features of the present claim 1 achieves these objects, and also achieves further objects which are a necessary consequence of the above discussion or result directly therefrom. The subclaims dependent on the said claim describe particularly advantageous embodiments of the moulding composition, and the further claims relate to particularly advantageous applications of the compositions.

Provision of a composition which comprises, in each case based on the total weight of the composition,

A) from 83% by weight to 99.5% by weight of a polymer matrix which is composed of at least one (meth)acrylimide (co)polymer,

B) from 0.5% by weight to 15.0% by weight of ceramic beads,

where the melt volume index MVR of the moulding composition, measured to ISO 1133 at 260° C. using 10 kg, is from 1.0 cm³/10 min to 20.0 cm³/10 min provides a method not readily foreseeable for access to a moulding composition which has excellent suitability for production of mouldings with a fine-matt surface. The moulding composition here is processable and preparable in a comparably simple manner, in particular with relatively low energy cost, and also permits realization of demanding component geometries.

At the same time, the articles that can be produced from the moulding composition feature a combination of advantageous properties, composed of:
They have very good optical properties, in particular a comparatively homogeneous velvet-matt surface with very low gloss. This effect was further reinforced via an attractive surface roughness of the mouldings.
They exhibit excellent mechanical properties, in particular very good abrasion resistance, impact resistance and notched impact resistance, high modulus of elasticity and high tensile strength, high scratch hardness and high Vicat softening point, and also low coefficient of thermal expansion.
The long-term stability and weathering resistance of the mouldings is likewise excellent.

### BRIEF DESCRIPTION OF THE INVENTION

### Polymer Matrix A)

Polymer matrix A) is composed of at least one (meth)acrylimide (co)polymer.

Preparation processes for the polymethacrylimides mentioned are disclosed by way of example in EP-A 216 505, EP-A 666 161 or EP-A 776 910.

The starting material used for imidation comprises a polymer derived from alkyl esters of methacrylic acid and generally composed of more than 50.0% by weight, preferably of more than 80.0% by weight, particularly preferably of from 95.0% by weight to 100.0% by weight, of units of alkyl esters of methacrylic acid having from 1 to 4 carbon atoms in the alkyl radical. Methyl methacrylate is preferred. Preferred polymers are composed of at least 80.0% by weight, preferably of more than 90.0% by weight, particularly preferably of more than 95.0% by weight, of methyl methacrylate. Comonomers that can be used comprise any of the monomers copolymerizable with methyl methacrylate, in particular alkyl esters of acrylic acid having from 1 to 4 carbon atoms in the alkyl radical, acrylo- or methacrylonitrile, acryl- or methacrylamide, styrene, or else maleic anhydride. Preference is given to thermoplastically processable polymers of this type whose reduced viscosity is in the range from 20 ml/g to 92 ml/g, preferably from 50 ml/g to 80 ml/g (measured to ISO 8257, part 2). They are used in the form of powder or pellets whose median particle size is from about 0.03 mm to 3 mm.

It is significant that, in a step (a) of the process, ammonia is first used as imidating agent, and that, in a subsequent step (b) of the process, methylamine is used, and that the molar ratio of ammonia used to the methylamine used is from 1:0.5 to 1:3, preferably from 1:0.8 to 1:2.7, particularly preferably from 1:0.9 to 1:1.1. Below this range, haze can occur to an increased extent in the polymethacrylimide obtained. If there is a molar excess of methylamine, based on the ammonia used, the proportion of carboxylic acid groups in the polymer in turn rises undesirably.

The process can be carried out continuously or batchwise. In the latter case, the ammonia is added at the beginning of the reaction in step (a) of the process, and the methylamine is added gradually or in one or more portions after reaction of the ammonia in step (b) of the process. By way of example, the imidating agent can be injected using a pressure pump uniformly or in periodic proportions into the reactor heated to reaction temperature. If appropriate, the gas phase accumulated in the reactor is depressurized before each addition of a further portion of the imidating agent, thus removing, from the reaction mixture, the volatile reaction products formed prior to that juncture.

In the case of a continuous mode of operation, the imidation is advantageously carried out in a tubular reactor, and the polymer and the imidating agent are continuously introduced into the tubular reactor. At a first inlet aperture, the first portion of the imidating agent, the ammonia, is introduced, and is mixed with the molten polymer. Further portions of the imidating agent can be introduced into the tubular reactor at one or more sites at which all or some of the previously introduced imidating agent has been reacted. A single- or multiscrew extruder is preferably used as tubular reactor. Here again, pressure zones and devolatilization zones can alternate with one another, in order that the volatile reaction products formed up to that juncture are removed from the reaction mixture gradually conveyed onward within the extruder, before each addition of further imidating agent.

By way of example, 1 underlying mol of polymethyl methacrylate (where the term “underlying mol” refers to the amount of the ester monomer underlying the polymerized ester units) can be reacted in step (a) of the process with from 0.1 to 1 mol of ammonia. Good results are obtained, for example, with from 0.2 to 0.8 mol of ammonia, and from 0.4 to 0.6 mol is particularly preferred. The ammonia can preferably be added in one to five additions. After substantial reaction of the ammonia, the addition of methylamine then follows in step (b) of the process in a molar ratio, based on the total amount used of the ammonia, of from 0.5 to 3, preferably from 0.8 to 2.7, particularly preferably from 0.9 to 1.1. It is particularly advantageous for the molar ratio of ammonia used to methylamine used to be from 1:0.5 to 1:0.8. Addition of the methylamine can take place analogously, preferably in from one to five additions. Here again, it is advisable when adding portional amounts to use in each case only up to about 75% of the amount previously used.

The reaction with the imidating agent is preferably terminated before the polymer has been completely imidated. To this end, the total amount used of the imidating agents can, for example, be from 0.2 to 2.5 mol, preferably from 0.5 to 1.5 mol, particularly preferably from 0.8 to 1.2 mol, per underlying mol of the ester units. However, the defined quantitative ratio of ammonia to methylamine is always to be maintained. This then gives polymers which are composed of from about 20 underlying mol % to 80 underlying mol % of cyclic methacrylimide units, and which have only extremely small amounts, less than 0.5% by weight, of methacrylic acid units.

The imidation process can be carried out substantially in a manner known per se, e.g. as described in EP 441 148. The imidation proceeds best at temperatures above the melting point or at least 20° C. above the Vicat B softening point to ISO 306 for the starting polymer. It is more preferable to select a reaction temperature which is at least 20° C. above the softening point of the resultant imidated polymer. Since the Vicat softening point of the imidated polymer is generally the target variable of the process, and the degree of imidation to be achieved is defined in accordance therewith, it is likewise readily possible to determine the required minimum temperature. A temperature range of from 140° C. to 300° C. is preferred, in particular from 150° C. to 260° C., particularly preferably from 180° C. to 220° C. Excessively high reaction temperatures sometimes lead to a reduction in viscosity caused by some extent of chain termination of the polymer. In order to prevent unnecessary thermal stressing of the polymer, the reaction temperature can, for example, be raised gradually or in stages, starting from a temperature slightly above the melting point of the starting polymer, and only at a final juncture exceed the softening point of the imidated end product by at least 20° C. Within the stages of the reaction, it is preferable to operate with autogenous pressure, which can be from 50 bar to 500 bar. Depressurization can be carried out during the stages of the process, e.g. for devolatilization. The temperature of the reaction mixture can fall here and must then be increased back to the required value. If imidating agent is introduced under reaction conditions, an appropriately high pressure must, of course, be used for this purpose.

The reaction time depends on the reaction rate under the conditions used. It can be markedly shorter than the reaction time that would be needed for complete imidation, but is always to be sufficient to ensure partial imidation of the polymer, e.g. from 20 to 80% imidation, preferably from 30 to 60% imidation. From 10 sec to 30 min, preferably from 1 min to 7 min, per stage of the process, are generally sufficient for this. A guideline value that can be used is from 4 min to 6 min.

The reaction can, if desired, be carried out in one or both stages of the process in the presence of solvents or diluents, as disclosed by way of example in U.S. Pat. No. 2,146,209, DE 1 077 872, DE 1 088 231 or EP 234 726. Suitable solvents are especially those which at room temperature are liquid and which at an elevated temperature, if appropriate at subatmospheric pressure, are volatile, and can be readily separated from the imidated polymer. They can be solvents either for the starting polymer or for the imidated polymer, or for both, if appropriate only under reaction conditions, but this is not fundamentally necessary. Among the solvents and diluents that can be used are mineral oils, petroleum hydrocarbons, aromatics, alkanols, ethers, ketones, esters, halogenated hydrocarbons, and also water.

After the final stage of the reaction, depressurization is carried out and the imidated polymer is cooled. Any solvent or diluent used concomitantly can be removed here, together with excess imidating agent and eliminated alkanol, from the imidated polymer. In a particularly advantageous design of this stage of the process, the process is carried out, at least in the final stage, in a tubular reactor, in particular in an extruder. The substances to be removed from the polymer can be extracted in liquid form or in vapour form prior to the end of the tubular reactor at one or more sites where the polymer is still molten. The first proportion of these substances can be extracted here under full reaction pressure, and the final residues can be extracted at subatmospheric pressure from a vent zone. Known single- or multistage vented extruders can be used for this purpose. If appropriate, the entire reaction mixture can also be discharged from the tubular reactor, depressurized, cooled and comminuted, and only thereafter separated from the by-products. To this end, the cooled and comminuted polymer can be washed with a suitable solvent or with water.

The resultant imidated product can be processed in a manner known per se, e.g. by thermoplastic methods. Because of the extremely low content of methacrylic acid groups in the polymer, it features good miscibility and compatibility with other polymers. Weathering resistance is likewise very good, since water absorption under moist conditions has been markedly reduced. The relatively high proportion of anhydride groups in comparison with the carboxy groups appears not to play any significant part here. This could, for example, be attributable to the fact that the anhydride groups have relatively good protection from hydrolytic exposure of moisture within the interior of the polymer molecule. The inventive process can give a high-performance N-alkylpolymethacrylimide in a process comprising two steps which are easy to carry out.

Partial or complete imidation of polymers of alkyl esters of methacrylic acid via reaction with an imidating agent, for example with a primary amine, is disclosed by way of example in U.S. Pat. No. 2,146,209. The polymer is heated to temperatures of from 140° C. to 250° C. in the presence or absence of a solvent with the imidating agent, if appropriate under pressure.

EP 216 505 discloses that polymethacrylimides are incompatible with other thermoplastic polymers if they contain more than about from 0.3 to 0.4 milliequivalents of carboxylic acid groups or of carboxylic anhydride groups. This corresponds to a content of from 2.5% by weight to 3.5% by weight of methacrylic acid units and/or methacrylic anhydride units. These units are produced alongside N-alkylmethacrylimide units during reaction of polymethyl methacrylate with primary amines. At high imidation rates, i.e. if 95% or more of the imidatable groups of the polymer have been reacted to give imide groups, the content of carboxylic acid groups or of anhydride groups is generally below the abovementioned limit. However, lower degrees of imidation, below 95%, are often desired, and increased formation of carboxylic acid groups or of anhydride groups is therefore problematic.

EP 456 267 (U.S. Pat. No. 5,135,985) describes N-alkylpolymethacrylimides having less than 2.5% by weight of methacrylic acid units, which can be prepared via homogeneous mixing of N-alkylpolymethacrylimides with different degrees of imidation. Again, this mode of preparation is very complicated, since polymers with a different degree of imidation constantly have to be provided as raw materials for preparation of an N-alkylpolymethacrylimide.

EP 441 148 (U.S. Pat. No. 5,110,877) describes a process for imidation of a polymer of alkyl esters of methacrylic acid via reaction with an imidating agent, in which a portion of the imidating agent is added only after at least partial or complete reaction of the previously added imidating agent. Suitable imidating agents mentioned are ammonia or primary amines, e.g. methylamine. The process permits preparation of

N-alkylpolymethacrylimides with low contents of methacrylic acid units: 1.3% by weight or 1.7% by weight, with degrees of imidation of about 80%. In comparison with this, the content of methacrylic acid units is stated as 4.9% by weight for the non-inventive standard process.

According to the teaching of EP 216 505, the miscibility of N-alkylpolymethacrylimides with other thermoplastic polymers is improved if the methacrylic acid units and/or methacrylic anhydride units are reacted via post-treatment of the polymer with an alkylating agent, such as orthoformic esters, with formation of methacrylic ester units. This method can be used by way of example to prepare N-alkylpolymethacrylimides having less than 0.1 milliequivalents of acid groups per g (about 0.8% by weight) with degrees of imidation of about 60% by weight. Although the post-alkylation is therefore very effective, it requires an additional and expensive step in the process.

In practice it is often found that in particular carboxylic acid units are disadvantageous in N-alkylpolymethacrylimides. In contrast, the undesired effects of carboxylic anhydride groups present remain within tolerable limits. It is therefore sufficient primarily to prepare a polymethacrylimide which is almost free from carboxylic acid groups.

A process for preparation of an imidated polymer of alkyl esters of methacrylic acid having a less than 0.5% by weight content, based on the polymer, of carboxylic acid units, via imidation of a polymer of alkyl esters of methacrylic acid in two steps (a) and (b) of the process can be characterized in that in the first step of the process
(a) ammonia is used as imidating agent,
   and in the second step of the process
(b) methylamine is used as imidating agent,
   where the molar ratio of the ammonia used to the methylamine used is from 1:0.5 to 1:3.

The process is easy to carry out and gives N-alkylpolymethacrylimides with degrees of imidation that are of practical use and which have very good practical properties, due to the low content of methacrylic acid units. It appears that, unexpectedly, the defined ratio of ammonia and methylamine here in steps (a) and (b) of the process obviously eliminates side reactions which lead to the presence of methacrylic acid units in the end product. It is astonishing that the effect of the content of carboxylic anhydride groups, which in comparison is relatively high, of about 5% by weight to 15% by weight, is not as disadvantageous as one might assume on the basis of the prior art. The polymers obtained have high Vicat softening points and very good processability.

The starting material used for imidation comprises a polymer derived from alkyl esters of methacrylic acid and generally composed of more than 50% by weight, preferably of more than 80% by weight, particularly preferably from 95% by weight to 100% by weight, of units of alkyl esters of methacrylic acid having from 1 to 4 carbon atoms in the alkyl radical. Methyl methacrylate is preferred. Preferred polymers are composed of at least 80% by weight, preferably of more than 90% by weight, particularly preferably of more than 95% by weight, of methyl methacrylate. Comonomers that can be used are any of the monomers copolymerizable with methyl methacrylate, in particular alkyl esters of acrylic acid having from 1 to 4 carbon atoms in the alkyl radical, acrylo- or methacrylonitrile, acryl- or methacrylamide, or styrene or else maleic anhydride. Preference is given to thermoplastically processable polymers of this type whose reduced viscosity is in the range from 20 ml/g to 92 ml/g, preferably from 50 ml/g to 80 ml/g (measured to ISO 8257, part 2). They are used in the form of powder or pellets whose median particle size is about 0.03 mm to 3 mm.

### Matting Agent B): Ceramic Beads

The inventive moulding composition moreover comprises from 0.5% by weight to 15.0% by weight of ceramic beads. Ceramics are articles substantially moulded at room temperature from inorganic, fine-particle raw materials with addition of water, and then dried, and sintered in a subsequent firing process above 900° C. to give hard, relatively durable articles. The term also includes materials based on metal oxides. The group of the ceramics that can be used according to the invention moreover also comprises fibre-reinforced ceramic materials, e.g. silicon carbide ceramics which can by way of example be prepared from silicon-containing organic polymers (polycarbosilanes) as starting material.

It is advantageous that the ceramic beads have no covalent bonding to the polymer matrix and that they can in principle be separated from the polymer matrix via physical separation methods, e.g. extraction processes using suitable solvents, e.g. tetrahydrofuran (THF).

Furthermore, the ceramic beads preferably have a spherical shape, but small deviations from the perfect spherical shape can, of course, occur.

The diameter of the ceramic beads is advantageously in the range from 1 to 200 μm. The median diameter (median value D₅₀) of the ceramic beads is preferably in the range from 1.0 μm to 15.0 μm. The D95 value is preferably smaller than or equal to 35 μm, particularly preferably smaller than or equal to 13 μm. The maximum diameter of the beads is preferably smaller than or equal to 40 μm, particularly preferably smaller than or equal to 13 μm. The particle size of the beads is preferably determined via sieve analysis.

The density of the ceramic beads is advantageously in the range from 2.1 g/cm³ to 2.5 g/cm³.

The specific constitution of the ceramic beads is of subordinate significance for the present invention. Preferred beads comprise, in each case based on their total weight,
from 55.0% by weight to 62.0% by weight of SiO₂,
particularly preferably non-crystalline SiO₂,
from 21.0% by weight to 35.0% by weight of Al₂O₃,
up to 7.0% by weight of Fe₂O₃,
up to 11.0% by weight of Na₂O and
up to 6.0% by weight of K₂O.

The surface area of the ceramic beads, measured by the BET nitrogen-adsorption method, is preferably in the range from 0.8 m²/g to 2.5 m²/g.

For the purpose of the present invention, it has moreover proven particularly successful to use ceramic beads which are internally hollow. The ceramic beads here preferably have sufficient compressive strength to prevent destruction of more than 90% of the beads when a pressure of 410 MPa is applied.

For the purposes of the present invention, very particularly suitable ceramic beads are, inter alia, Zeeospheres® from 3M Deutschland GmbH, in particular grades W-210, W-410, G-200 and G-400.

Conventional Additives, Auxiliaries and/or Fillers

The inventive moulding composition can also comprise conventional additives, auxiliaries and/or fillers, e.g. heat stabilizers, UV stabilizers, UV absorbers, antioxidants, and in particular soluble or insoluble dyes and, respectively, other colorants.

### UV Stabilizers and Free-Radical Scavengers

Examples of optionally present UV stabilizers are derivatives of benzophenone, its substituents such as hydroxy and/or alkoxy groups, being mostly in 2- and/or 4-position. Among these are 2-hydroxy-4-n-octoxybenzophenone, 2,4-dihydroxybenzophenone, 2,2′-dihydroxy-4-methoxybenzophenone, 2,2′,4,4′-tetrahydroxybenzophenone, 2,2′-dihydroxy-4,4′-dimethoxybenzophenone, 2-hydroxy-4-methoxybenzophenone. Substituted benzotriazoles are moreover very suitable as UV stabilizer additive, and among these are especially 2-(2-hydroxy-5-methylphenyl)benzotriazole, 2-[2-hydroxy-3,5-di-(alpha, alpha-dimethylbenzyl)phenyl]benzotriazole, 2-(2-hydroxy-3,5-di-tert-butylphenyl)benzotriazole, 2-(2-hydroxy-3,5-butyl-5-methylphenyl)-5-chlorobenzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-butylphenyl)benzotriazole, 2-(2-hydroxy-3-sec-butyl-5-tert-butylphenyl)benzotriazole and 2-(2-hydroxy-5-tert-octylphenyl)benzotriazole.

Other UV stabilizers that can be used are ethyl 2-cyano-3,3-diphenylacrylate, 2-ethoxy-2′-ethyloxanilide, 2-ethoxy-5-tert-butyl-2′-ethyloxanilide and substituted phenyl benzoates.

The UV stabilizers can be present in the form of low-molecular-weight compounds, as given above, in the polymethacrylate compositions to be stabilized. However, it is also possible that UV-absorbent groups have covalent bonding within the matrix polymer molecules after copolymerization with polymerizable UV-absorption compounds, e.g. acrylic, methacrylic or allyl derivatives of benzophenone derivatives or of benzotriazole derivatives.

The proportion of UV stabilizers, and this can also be mixtures of chemically different UV stabilizers, is generally from 0.01% by weight to 1.0% by weight, especially from 0.01% by weight to 0.5% by weight, in particular from 0.02% by weight to 0.2% by weight, based on the entirety of all of the constituents of the inventive polymethacrylate resin.

An example that may be mentioned here as free-radical scavengers/UV stabilizers is sterically hindered amines, known as HALS (Hindered Amine Light Stabilizer). They can be used for inhibiting ageing processes in coatings and plastics, especially in polyolefin plastics (Kunststoffe, 74 (1984) 10, pp. 620 to 623; Farbe+Lack, Volume 96, 9/1990, pp. 689 to 693). The tetramethylpiperidine group present in the HALS compounds is responsible for their stabilizing action. This class of compounds can have no substitution on the piperidine nitrogen or else have substitution thereon by alkyl or acyl groups. The sterically hindered amines do not absorb in the UV region. They scavenge free radicals formed, the function of which the UV absorbers are in turn not capable.

Examples of HALS compounds having stabilizing action, which can also be used in the form of mixtures, are: bis(2,2,6,6-tetramethyl-4-piperidyl)sebacate, 8-acetyl-3-dodecyl-7,7,9,9-tetramethyl-1,3,8-triazaspiro(4,5)decane-2,5-dione, bis(2,2,6,6-tetramethyl-4-piperidyl)succinate, poly(N-β-hydroxyethyl-2,2,6,6-tetramethyl-4-hydroxypiperidine succinate) or bis(N-methyl-2,2,6,6-tetramethyl-4-piperidyl)sebacate.

The amounts used of the free-radical scavengers/UV stabilizers in the inventive moulding compositions are from 0.01% by weight to 1.5% by weight, especially from 0.02% by weight to 1.0% by weight, in particular from 0.02% by weight to 0.5% by weight, based on the entirety of all of the constituents.

### Lubricants or Mould-Release Agents

Lubricants or mould-release agents are particularly important for the injection-moulding process, and can reduce or entirely prevent any possible adhesion of the moulding composition to the injection mould.

Auxiliaries that can accordingly be present comprise lubricants, e.g. selected from the group of the saturated fatty acids having fewer than 20, preferably from 16 to 18, carbon atoms, or from that of the saturated fatty alcohols having fewer than 20, preferably from 16 to 18, carbon atoms. Small quantitative proportions are preferably present: at most 0.25% by weight, e.g. from 0.05% by weight to 0.2% by weight, based on the moulding composition.

Examples of suitable materials are stearic acid, palmitic acid, and technical mixtures composed of stearic and palmitic acid. Other examples of suitable materials are n-hexadecanol and n-octadecanol, and also technical mixtures composed of n-hexadecanol and n-octadecanol.

Stearyl alcohol is a particularly preferred lubricant or mould-release agent.

### Preparation of Inventive Moulding Composition

The inventive moulding composition can be prepared via dry blending of the components, which can take the form of powders, grains or preferably pellets. They can moreover also be prepared via melting and mixing in the melt of the polymer matrix and, if appropriate, of the impact modifier, or via melting of dry premixes of individual components, and addition of the ceramic beads. This can take place, for example, in single- or twin-screw extruders. The extrudate obtained can then be pelletized. Conventional additives, auxiliaries and/or fillers can be directly admixed or subsequently admixed by the end user as required.

### Processing to Give Mouldings

The inventive moulding composition is a suitable starting material for production of mouldings with a velvet-matt and preferably rough surface. The forming process to which the moulding composition is subjected can take place in a manner known per se, e.g. via processing by way of the elastoviscous state, e.g. via kneading, rolling, calendering, extrusion or injection moulding, preference being presently given to extrusion and injection moulding, in particular extrusion.

The moulding composition can be injection-moulded in a manner known per se at temperatures in the range from 240° C. to 300° C. (melt temperature) and at a mould temperature which is preferably from 70° C. to 150° C. When moulds are used whose mould cavities have smooth or polished interior surfaces (cavities), matt mouldings are obtained. When moulds are used whose mould cavities have rough interior surfaces (cavities), the mouldings obtained are even more intensely matt.

Extrusion is preferably carried out at a temperature of from 220° C. to 260° C.

### Mouldings

The mouldings thus obtainable preferably feature the following properties:

The roughness value R_{z} to DIN 4768 is advantageously greater than or equal to 0.3 μm, preferably at least 0.7 μm, particularly preferably from 2.5 μm to 20.0 μm. Gloss (R 60°) to DIN 67530 (January 1982) is preferably at most 45, particularly preferably at most 38. Vicat softening point VSP (ISO 306-B50) is preferably at least 90° C., particularly preferably at least 100° C., very particularly preferably at least 110° C., and is advantageously from 110° C. to 200° C., in particular from 125° C. to 180° C.

Transmittance to DIN 5036 is preferably in the range from 40% to 93%, particularly preferably in the range from 55% to 93%, in particular in the range from 55% to 85%. The halved-intensity angle to DIN 5036 is preferably in the range from 1° to 55°, particularly preferably in the range from 2° to 40°, in particular in the range from 8° to 37°.

The moulding moreover preferably has one or more of the following properties, and particularly preferably as many as possible of these:
I. tensile stress at break to ISO 527 (5 mm/min) in the range from 80 to 110 MPa,
II. modulus of elasticity to ISO 527 (1 mm/min) greater than 4000 MPa,
III. impact resistance to ISO 179/1eU greater than 20 kJ/m² and
IV. linear coefficient of expansion to ISO 11359 smaller than 6*10⁻⁵/° K.

### Uses

The inventive mouldings can in particular be used as parts of household devices, of communications devices, of hobby equipment or of sports equipment, or as bodywork parts or parts of bodywork parts in automobile construction, shipbuilding or aircraft construction, or as parts for illuminants, signs or symbols, retail outlets or cosmetics counters, containers, household-decoration items or office-decoration items, furniture applications, shower doors and office doors, or else as parts, in particular sheets, in the construction industry, as walls, in particular as noise barriers, as window frames, bench seats, lamp covers, diffuser sheets, or for automobile glazing. Examples of typical exterior automobile parts are spoilers, panels, roof modules or exterior-mirror housings.

1. A moulding composition, comprising, in each case based on the total weight of the moulding composition,
A) from 83% by weight to 99.5% by weight of a polymer matrix which is composed of at least one (meth)acrylimide (co)polymer, and
B) from 0.5% by weight to 17.0% by weight of ceramic beads,
wherein
the melt volume index MVR of the moulding composition, measured to ISO 1133 at 260° C. using 10 kg, is from 1.0 cm³/10 min to 20.0 cm³/10 min.

2. The moulding composition according to claim 1, wherein the ceramic beads have no covalent bonding to the polymer matrix.

3. The moulding composition according to claim 1, wherein the median diameter of the ceramic beads, measured as D₅₀ value, is in the range from 1.0 μm to 15.0 μm.

4. The moulding composition according to claim 1, wherein the median diameter of the ceramic beads, measured as D₉₅ value, is in the range from 3 μm to 35 μm.

5. The moulding composition according to claim 1, wherein the density of the ceramic beads is in the range from 2.1 g/cm³ to 2.5 g/cm³.

6. The moulding composition according to claim 1, wherein the ceramic beads comprise, in each case based on their total weight,
from 55.0% by weight to 62.0% by weight of SiO₂,
from 21.0% by weight to 35.0% by weight of Al₂O₃,
up to 7.0% by weight of Fe₂O₃,
up to 11.0% by weight of Na₂O and
up to 6.0% by weight of K₂O.

7. The moulding composition according to claim 1, wherein the surface area of the ceramic beads, measured by the BET nitrogen-adsorption method, is in the range from 0.8 m²/g to 2.5 m²/g.

8. The moulding composition according to claim 1, wherein the ceramic beads are internally hollow.

9. The moulding composition according to claim 1, wherein a lubricant is present as auxiliary.

10. The moulding composition according to claim 9, wherein stearyl alcohol is present as lubricant.

11. The moulding composition according to claim 1, wherein it takes the form of moulding composition pellets.

12. A process for production of mouldings, wherein a forming process is carried out on a moulding composition according to claim 1.

13. The process according to claim 12, wherein the moulding composition is extruded or injection-moulded.

14. A moulding, capable of production by a process according to claim 12.

15. The moulding according to claim 14, wherein its roughness value Rz to DIN 4768 is at least 0.3 μm, and its gloss (R 60°) to DIN 67530 is at most 45.

16. The moulding according to claim 14, wherein its transmittance to DIN 5036 is in the range from 40% to 93% and its halved-intensity angle to DIN 5036 is in the range from 1° to 55°.

17. The moulding according to claim 14, wherein it has one or more of the following properties
a. a tensile stress at break to ISO 527 at 5 mm/min in the range from 80 MPa to 110 MPa,
b. a modulus of elasticity to ISO 527 at 1 mm/min greater than 4000 MPa,
c. an impact resistance to ISO 179/1eU greater than 20 kJ/m² and
d. a linear coefficient of expansion to ISO 11359 smaller than 6*10⁻⁵/° K., and
e. a Vicat softening point VSP (ISO 306-B50) of at least 125° C.

18. Parts of household devices, and communications devices, hobby and sports equipment, bodywork parts or parts of bodywork parts in automobile, shipbuilding or aircraft construction, parts for illuminants, signs or symbols, retail or cosmetics counters, containers, household-decoration or office-decoration items, furniture applications, shower and office doors, walls, window frames, bench seats, lamp covers, diffuser sheets, and automobile glazing comprising the moulding according to claim 14.
